(19) United States
(12) Patent Application Publication
(10) Pub. No.: US 2006/0066436 A1
(43) Pub. Date: Mar. 30, 2006

(54) Fuse for high-current applications

(75) Inventors: Wolfgang Langhoff, Leonberg (DE); Wolfgang Kerner, Erlenbach (DE); Hans-Ulrich Muller, Pfedelbach (DE)

Correspondence Address: BLANK ROME LLP, 600 NEW HAMPSHIRE AVENUE, N.W., WASHINGTON, DC, 20037, US

(73) Assignee: Amphenol-Tuchel Electronics GmbH, Heilbronn (DE)

(21) Appl. No.: 11/230,507

(22) Filed: Sep. 21, 2005

(30) Foreign Application Priority Data
Sep. 24, 2004 (DE) 10 2004 046 387.5

(51) Int. Cl. H01H 85/46; H01H 85/02

(52) U.S. Cl. 337/187

(57) ABSTRACT

The present invention relates to a fuse for high-current applications, especially in the automobile area, comprising a conducting element which has two connecting regions and an interposed fuse region, and a housing to protect the fuse region and the connecting regions wherein at least one interface is constructed in one piece with the conducting element to save assembly steps.

The present invention relates to a fuse for high-current applications which is especially used in the automobile area and consists of a conducting element with two connecting regions and an interposed fuse region.

Such fuses are usually used to protect an electrical circuit against a specific permanent overload or a short-circuit wherein the high current in ranges of around 30-200 amperes at mostly relative low voltage requires a particular design of fuse.

EP 0 627 120, for example, describes a fuse with a metal piece which contains an S-shaped fuse element between two connecting sections, this fuse element being protected by two housing halves. The housing formed from the housing halves is used to protect the fuse element during installation and from uncontrolled heat emission in the event of this being tripped by a short circuit current.

In fuses of this type a corresponding screw element is used for connection to a relevant wiring harness, this element being screwed into a further separate housing with the connecting element of the metal part and a connecting section for an incoming or extending lead. This housing forms the interface between the cable set and fuse as a separate part.

During the assembly process care should be taken to ensure that a sufficient tightening torque is applied to achieve a low transition impedance between the metal part and the clamped-in lead. However, the tightening torque must not be too high otherwise damage will occur. After assembling the wiring harness by screwing the fuse to the cable ends, the surrounding housing is folded together and sealed.

To protect the holes of the fuse connecting elements in which the screws are screwed in, for example, EP 0803889 discloses sleeves 35, 36 which serve as protection against breakaway.

The object of the invention is to provide a fuse which can be assembled more quickly and especially more cheaply.

The basic idea of the invention is to save an additional assembly step of the wiring harness at a connecting region of the fuse by configuring the interface with the conduction element as ready-made and equipping the fuse with only one housing to protect the fuse region and the connecting region. The fuse is thus constructed so that the conventional second housing is integrated in the fuse and simple (plug) assembly is possible.

The ready-made configuration can be accomplished, for example by rolling up the ends of the conducting elements until they have reached a certain diameter. Plugs already established on the market can simply be plugged onto this “roll” which is in one piece with the fuse. Such plugs are known from U.S. Pat. No. 4,734,063 and U.S. Pat. No. 4,657,335. In this way assembly steps are saved since the fuse can be connected to a corresponding plug or integrated in the wiring harness.

By directly integrating the interface of the wiring harness in the fuse, assembly is reduced to plugging on a suitable connector for which purpose the connecting regions of the fuse necessary in principle are formed so that the counter-contour is available for the plugging process. In addition, the conductivity of the fuse is improved by reducing the electrical transitions.

Furthermore, as a result of this design the fuse housing can be enlarged beyond the actual body region of the melting structure and take over the function of a plug connector housing. In this case, care can be taken to ensure interlocking/engaging and provision of a contour suitable for the seal.

Thus, a simple joining process can be used for integrating the fuse in the wiring harness.

“One-piece” in the sense of the present application comprises all components which are monolithic, soldered, riveted or welded.

Another advantage of the invention is that the assembly can take place without tools whereby sources of error caused by incorrect assembly are largely avoided. In particular, attention no longer needs to be paid to the tightening torque which is frequently incorrectly adjusted during screwing. In order to facilitate suitable plugging of the fuse, a contour which provides a suitable connector system for high current intensities needs to be provided. For example, the rolled geometry as an extension of the conducting element provides an ideal operative connection between the fuse and a standard contact socket attached thereto. In addition, an additionally attached housing surrounding and containing the connections of conventional fuses can be dispensed with.

In its most general embodiment the present invention thus relates to a fuse having the features of claim 1.

Further embodiments of the invention are obtained from the features of the dependent claims.

The figures in the drawings show in detail:

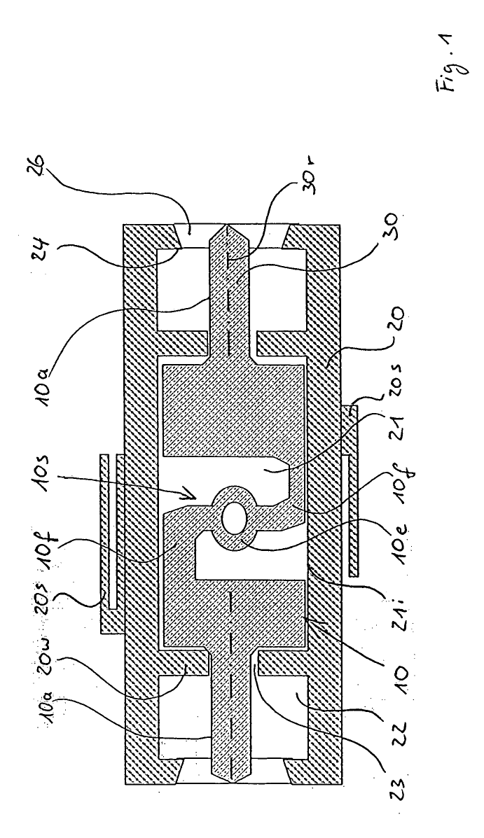

FIG. 1: A cutaway view of an embodiment of the fuse.

FIG. 1 shows a conducting element 10 which extends through a housing 20 wherein at respectively opposing ends of the conducting element 10 respectively one interface 30 is constructed in one piece with the conducting element 10. The interface 30 is created by forming a pin having a circular cross-section in one connecting region 10a of the conducting element 10, here embodied as the metal plate 10, by rolling up the metal plate in this section. A standard contact socket can be pushed directly onto this geometry whose diameter should be matched to the power range of the wiring harness or the fuse, whereby the fuse can be integrated directly in the wiring harness.

The housing 20 consists of a lower housing section and an upper housing section where the lower housing section and the upper housing section are joined together in a known fashion using pins and the pins are fixed by fixing means of the metal plate 10 which are not shown, for example through holes.

The conducting element 10 is undetachably connected to the interface 30, i.e. in one piece where the connection can be made, for example, by riveting, welding or soldering. Care should be taken to ensure that the connection has particularly good conductivity.

Alternatively, the rolled interfaces 30 can also be arranged at a different angle if special geometries of the installation location make this necessary. The interface 30 can also be formed in other geometrical shapes provided that this can be achieved in a one-piece shape. Thus, a triangular or square cross-section would also be feasible for example.

The fuse region 10s can have any configuration known in the prior art, wherein here a fuse element 10e of the metal plate 10/of the conducting element 10 is held by two sickle-shaped wings 10f moulded onto respectively opposite sides of the connecting regions 10a of the conducting element 10. The lead cross-section of the fuse element 10e and the wings 10f is significantly smaller than the cross-section of the metal plate 10 in the connecting region 10a whereby the resistance is highest at this point. In this situation, the fuse element 10e is designed by the choice of material, preferably tin, choice of lead cross-section and the length of the wings 10f and of the fuse element 10e, the current intensity and the applied voltage.

The housing 20 shown in cross-section has a housing chamber 21 which contains the fuse region 10s and parts of the connecting region 10a. In this case, the inner wall 21i of the housing chamber 21 or the housing 20 is so far from the fuse element 10e that in the event of said element being deformed by heat, any contact with the housing inner wall 21i is eliminated. Adjacent to the housing chamber 21 on the right and the left is respectively one interface housing chamber 22 which is separated by a wall 20w between the housing chambers 21 and 22, the wall 20w having a through opening 23 through which the rolled interface 30 penetrates. Sealing means which are not shown here can be provided in the through opening 23 for sealing the housing chamber 21. Openings 26 to receive a plug are provided on the respective outer ends of the interface housing chamber 22, the circumference of the opening being sloping for easier insertion of the plug.

The housing 20 can also be constructed in one piece/one part with a (flap) hinge.

The slope additionally forms a locking means 24 locating the plug or for gripping behind corresponding projections on the plug. The locking means 24 can be configured as a locating or bayonet connection.

An oversleeve or secondary lock for the plug can also be provided here in a known fashion to prevent unintentional separation of the plug connection. The interface and the housing can also be constructed as scoop-proofed.

In addition, the housing can have at least one structured outer wall 20s for arranging a plurality of fuses one after the other, which can be formed by a lateral swallowtail structure for example. This produces an alignable modular concept for the fuse which is frequently accommodated in a plurality in the smallest possible space where slippage of the fuses should be prevented.

The embodiment according to the invention also makes it possible to construct the fuse ready-made with the wiring harness.

Furthermore an eye, which is not shown, can also be provided on the housing 20 to fix the fuse on a motor vehicle.

1. A fuse for high-current applications, especially in the automobile area, comprising a conducting element (10) which has two connection regions (10a) and an interposed fuse region (10s), wherein at least one interface (30) is constructed in one piece with the conducting element (10) and is pluggable and wherein the fuse has a housing (20) to protect the fuse region (10s) and the connecting regions (10a).

2. The fuse according to claim 1, wherein the conducting element (10) is a metal plate (10).

3. The fuse according to claim 2, wherein the interface (30) is embodied as rolled or solid or folded.

4. The fuse according to claim 3, wherein the axis (30r) of the interface (30) lies in the plane formed by the metal plate (10) or is arranged parallel thereto.

5. The fuse according to claim 3, wherein the axis (30r) of the interface (30) projects from the plane formed by the metal plate (10), preferably at an angle of 90°.

6. The fuse according to claim 1, wherein the housing (20) consists of two housing sections which receive the fuse region (10s) in a housing chamber (21) and wherein inner walls (21i) of the housing chamber (21) are arranged at a distance from a fuse element (10e) of the metal plate (10).

7. The fuse according to claim 6, wherein the housing (20) has at least one interface housing chamber (22) in which the interface (30) is located, wherein the conducting element (10) extends through the housing chamber (21) and the interface jousing chamber(s) and wherein (in each case) a through opening (23) is provided between the housing chamber (21) and the interface housing chamber (22).

8. The fuse according to claim 7, wherein the housing chamber (21) is sealed from the interface housing chamber(s) (22) using a sealing means.

9. The fuse according to claim 6 or claim 7, wherein the interface housing chamber (22) has an opening (26) for receiving a plug.

10. The fuse according to claim 9, wherein a locking means (24) for locking the plug is provided at the opening (26) of the interface housing chamber (22).

11. The fuse according to claim 10, wherein the locking means (24) is secured by an oversleeve.

12. The fuse according to claim 1, wherein the housing (20) has at least one structure outer wall (20s) for arranging a plurality of fuses in a row.

13. The fuse according to claim 10 or claim 11, wherein the locking means (24) are embodied as locating or bayonet locking.

14. The fuse according to claim 1, wherein the housing (20) is constructed in one piece, preferably with a flap hinge.

15. The fuse according to claim 1, wherein at least one fixing means for fixing the fuse on the vehicle is provided on the housing (20).
